(19) United States
(12) Patent Application Publication
(10) Pub. No.: US 2021/0318944 A1
(43) Pub. Date: Oct. 14, 2021

(54) INFLUENCE ANALYSIS OF PROCESSES FOR REDUCING UNDESIRABLE BEHAVIOR

(71) Applicant: UiPath, Inc., New York, NY (US)

(72) Inventors: Celine VERHOEF, Nuenen (NL); Roeland Johannus SCHEEPENS, Eindhoven (NL); Paula SUBÍAS-BELTRÁN, Barcelona (ES)

(73) Assignee: UiPath, Inc., New York, NY (US)

(21) Appl. No.: 16/847,215

(22) Filed: Apr. 13, 2020

(51) Int. Cl. G06F 11/34; G06Q 30/04

(52) U.S. Cl. CPC G06F 11/3447; G06F 11/3414; G06Q 30/04

(57) ABSTRACT

Systems and methods for analyzing the influence of one or more attribute values on undesirable behavior exhibited in a set of cases of a process are provided. An observed frequency of occurrence of cases that are associated with one or more attribute values and exhibit undesirable behavior is determined. An expected frequency of occurrence of cases that are associated with the one or more attribute values and exhibit the undesirable behavior is calculated. The observed frequency of occurrence is compared with the expected frequency of occurrence to determine the influence of the one or more attribute values on the undesirable behavior. An impact metric quantifying the influence of the one or more attribute values on the undesirable behavior is computed.

### TECHNICAL FIELD

The present invention relates generally to process management, and more particularly to influence analysis of processes for reducing undesirable behavior.

### BACKGROUND

Processes are sequences of activities executed to provide products or services. In process mining, processes are analyzed to identify trends, patterns, and other process analytical measures in order to improve efficiency and gain a better understanding of the processes. One approach for improving the performance of processes is to reduce undesirable behavior of the processes, such as, e.g., exceeding a service level agreement. However, current process mining techniques are not able to determine attributes of the execution of the process that influence such undesirable behavior.

### BRIEF SUMMARY OF THE INVENTION

In accordance with one or more embodiments, systems and methods for analyzing the influence of one or more attribute values on undesirable behavior exhibited in a set of cases of a process are provided, where each case in the set of cases corresponds to an instance of execution of the process. The process may be a robotic process automation process.

In one embodiment, an observed frequency of occurrence of cases, in the set of cases, that are associated with one or more attribute values and exhibit undesirable behavior is determined. An expected frequency of occurrence of cases, in the set of cases, that are associated with the one or more attribute values and exhibit the undesirable behavior is calculated. The expected frequency of occurrence is calculated based on a proportion of cases, in the set of cases, that exhibit the undesirable behavior and a frequency of occurrence of cases, in the set of cases, that are associated with the one or more attribute values. The observed frequency of occurrence is compared with the expected frequency of occurrence to determine the influence of the one or more attribute values on the undesirable behavior. An impact metric quantifying the influence of the one or more attribute values on the undesirable behavior is computed.

In one embodiment, the expected frequency of occurrence is calculated by multiplying the proportion of cases, in the set of cases, that exhibit the undesirable behavior by the frequency of occurrence of cases, in the set of cases, that are associated with the one or more attribute values.

In one embodiment, comparing the observed frequency of occurrence with the expected frequency of occurrence is performed by computing a standard residual of the cases, in the set of cases, that are associated with the one or more attribute values and exhibit the undesirable behavior based on the observed frequency of occurrence and the expected frequency of occurrence. The comparing may be performed in response to the expected frequency of occurrence of cases, in the set of cases, that are associated with the one or more attribute values and exhibit the undesirable behavior and an expected frequency of occurrence of cases, in the set of cases, that are associated with the one or more attribute values and do not exhibit the undesirable behavior satisfying an expected frequency threshold.

In one embodiment, the impact metric is computed by determining that the impact metric will be positive and computing the positive impact metric based on a frequency of occurrence of cases, in the set of cases, that exhibit the undesirable behavior and a frequency occurrence of cases, in the set of cases, associated with the one or more attribute values. In another embodiment, the impact metric is computed by determining that the impact metric will be negative and computing the negative impact metric based on a frequency of occurrence of cases, in the set of cases, that do not exhibit the undesirable behavior and a frequency occurrence of cases, in the set of cases, associated with the one or more attribute values.

In one embodiment, a dashboard of results of the comparing may be displayed on a display device.

These and other advantages of the invention will be apparent to those of ordinary skill in the art by reference to the following detailed description and the accompanying drawings.

### BRIEF DESCRIPTION OF THE DRAWINGS

FIG. 1 shows an illustrative process which may be analyzed in accordance with one or more embodiments of the invention;

FIG. 2 shows a method for analyzing influence of attribute values on undesirable behavior exhibited during execution of a process, in accordance with one or more embodiments of the invention;

FIG. 3 shows an exemplary table of case data of a process, in accordance with one or more embodiments of the invention;

FIG. 4 shows an exemplary output table of results of analyzing influence of attribute values on undesirable behavior, in accordance with one or more embodiments of the invention;

FIG. 5 shows a dashboard for visualizing the influence of attribute values on undesirable behavior, in accordance with one or more embodiments of the invention;

FIG. 6 shows a dashboard for analyzing a deviation of observed frequency from the expected frequency of cases associated with various attribute values that exhibit undesirable behavior, in accordance with one or more embodiments of the invention;

FIG. 7 shows a dashboard showing impact metric values for various attribute values based on frequencies of occurrence, in accordance with one or more embodiments of the invention;

FIG. 8 shows a dashboard showing impact metric values for various attribute values based on weights, in accordance with one or more embodiments of the invention;

FIG. 9 shows a dashboard visualizing the influence of attribute values on undesirable behavior for an exemplary use case, in accordance with one or more embodiments of the invention; and

FIG. 10 is a block diagram of a computing system according to an embodiment of the invention.

### DETAILED DESCRIPTION

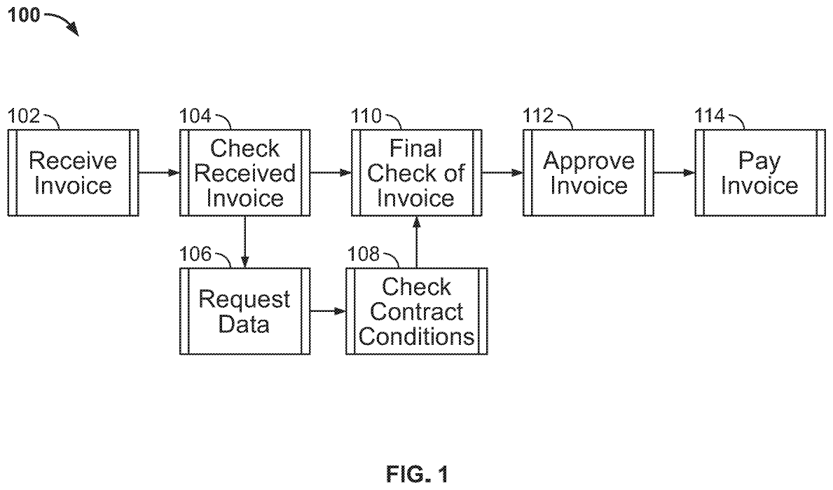

Processes may be utilized to provide services for a number of different applications, such as, e.g., administrative applications (e.g., onboarding a new employee), procure-to-pay applications (e.g., purchasing, invoice management, and facilitating payment), and information technology applications (e.g., ticketing systems). An exemplary process 100 is shown in FIG. 1. Process 100 is a process for processing and paying invoices. In one embodiment, process 100 may be implemented as a robotic process automation (RPA) workflow for automatically performing a task using one or more RPA robots.

Process 100 comprises activities 102-114, which represent a predefined sequence of steps in process 100. As shown in FIG. 1, process 100 is modeled as a directed graph where each activity 102-114 is represented as a node and each transition between activities 102-114 is represented as edges linking the nodes. The transition between activities represents the execution of process 100 from a source activity to a destination activity. Execution of process 100 is recorded in the form of an event log.

Process 100 starts at Receive Invoice activity 102 and proceeds to Check Received Invoice activity 104. If the received invoice is determined to be missing information at Check Received Invoice activity 104, process 100 proceeds to Request Data activity 106 and Check Contract Conditions activity 108 before proceeding to Final Check of Invoice activity 110. If the received invoice is determined to not be missing information at Check Received Invoice activity 104, process 100 proceeds directly to Final Check of Invoice activity 110. Process 100 then proceeds to Approve Invoice activity 112 and Pay Invoice activity 114.

Each instance of execution of process 100 corresponds to a case, identified by a case ID. Each case may have a number of attributes with corresponding values (referred to as attribute values). In one example, an attribute may be case type and attribute values may be services or catalog. In another example, an attribute may be supplier and attribute values may be the names of the suppliers. During one or more instances of execution of process 100, undesirable behavior may be exhibited. Undesirable behavior exhibited during an instance of execution is also referred to herein as a tag. An example of undesirable behavior is exceeding a service level agreement or late payment of an invoice. In accordance with embodiments described herein, the influence of attribute values is analyzed by comparing the observed frequency of occurrence of attribute values for a set of cases that exhibit undesirable behavior with the expected frequencies of occurrence.

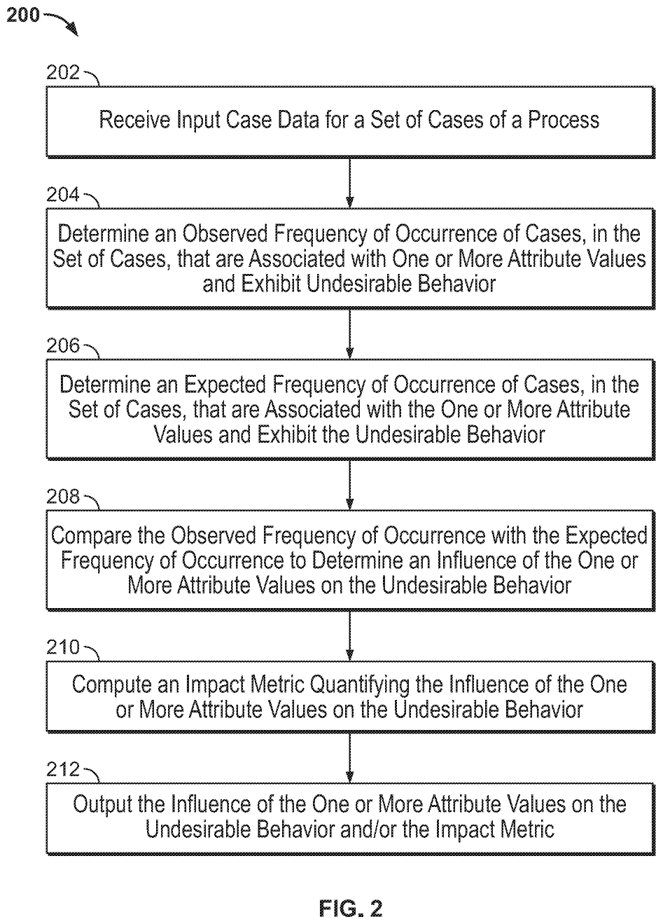

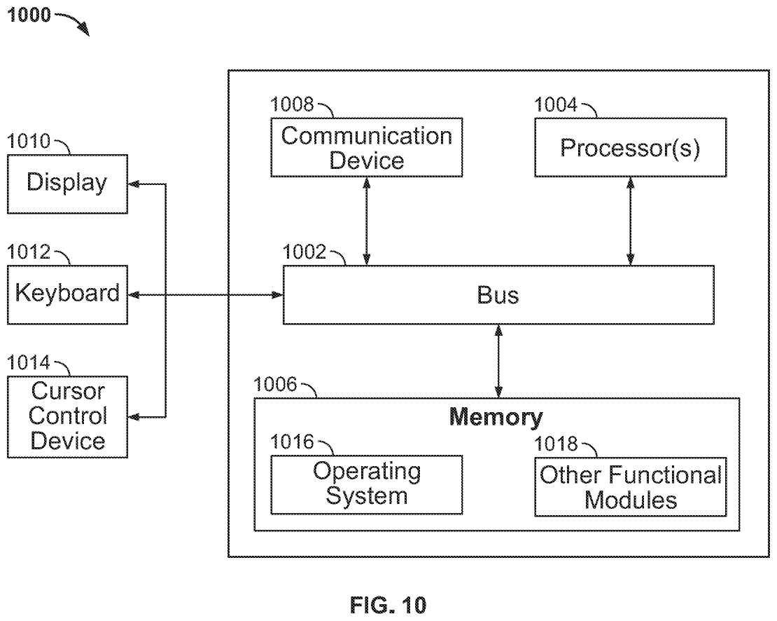

FIG. 2 shows a method 200 for analyzing influence of attribute values on undesirable behavior exhibited during one or more instances of execution of a process, in accordance with one or more embodiments. Method 200 may be performed by one or more suitable computing devices, such as, e.g., computing system 1000 of FIG. 10.

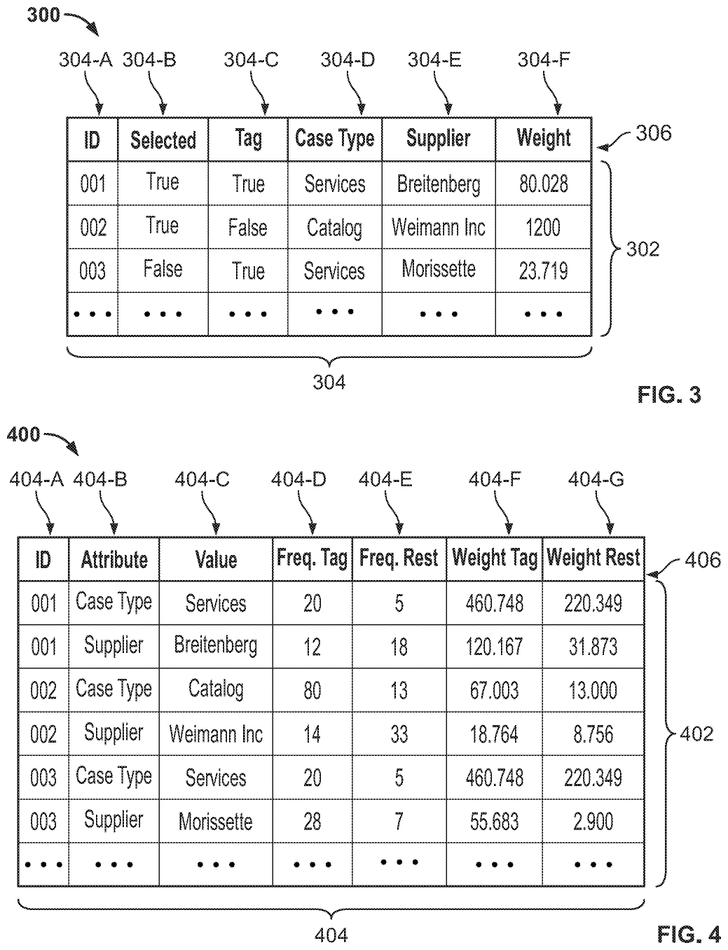

At step 202, input case data is received for a set of cases of a process. Each case corresponds to an instance of execution of the process. An example of the process is process 100 of FIG. 1. The input case data identifies one or more attribute values for each case and whether undesirable behavior was exhibited during each case. The undesirable behavior may include any behavior exhibited during a case that the user considers undesirable, such as, e.g., exceeding service level agreements or late payment of an invoice. In one embodiment, the set of cases and the undesirable behavior are selected by a user. The input case data may be in the format of a table, such as, e.g., table 300 of FIG. 3, or may be in any other suitable format.

FIG. 3 shows an exemplary table 300 of case data of a process, in accordance with one or more embodiments. Table 300 may be the input case data received at step 202 of FIG. 2. As shown in FIG. 3, table 300 comprises headings 306 and rows 302 each corresponding to a case of the process and columns 304 identifying various properties of the cases at a cell at which rows 302 and columns 304 intersect. In particular, each row 302 corresponds to a case, which is associated with a case ID (identified in column 304-A) identifying an instance of execution of the process, an indication of whether the case was selected by the user to be included in the set of cases for analysis (identified in column 304-B), an indication of whether undesirable behavior was exhibited during the case (referred to as a tag, as identified in column 304-C), various attributes of the case such as case type (identified in column 304-D) and supplier (identified in column 304-E), and (optionally) a weight associated with each case (identified in column 304-F).

As shown in FIG. 3, table 300 identifies attribute values for each attribute. For example, as shown in column 304-D, the attribute “case type” has the attribute value “services” for cases associated with case ID 001 and 003 and “catalog” for the case associated with case ID 002. In another example, as shown in column 304-E, the attribute “supplier” has the attribute value “Breitenberg” for the case associated with case ID 001, “Weimann Inc” for the case associated with case ID 002, and “Morissette” for the case associated with case ID 003. The weight associated with each case is optionally included in table 300 and is defined by the user based on, e.g., the costs involved in that case or any other factor. It should be understood that table 300 may be in any suitable format and may include additional columns 304 identifying other attributes.

At step 204 of FIG. 2, an observed frequency of occurrence of cases, in a set of cases, that are associated with one or more attribute values and exhibit undesirable behavior is determined. In one embodiment, the set of cases may be cases selected by a user, for example, as indicated in the input case data. The observed frequency of occurrence may be determined from the input case data. For example, where the input case data is table 300 of FIG. 3, the observed frequency of occurrence of cases, in the set of cases selected by the user, that are associated with the attribute value “services” and exhibit undesirable behavior is 1 (corresponding to case ID 001, since case ID 002 is not associated with “services” and case ID 003 is not selected). Similarly, such an observed frequency of occurrence may be determined for the attribute value “catalog” as being 0, the attribute value “Breitenberg” as being 1, the attribute value “Weimann Inc” as being 0, and the attribute value “Morissette” as being 0.

In one embodiment, the one or more attribute values may be a single attribute value. In another embodiment, the one or more attribute values may be a combination of attribute values. Accordingly, the influence on a combination of attribute values on the undesirable may be analyzed according to method 200.

At step 206, an expected frequency of occurrence of cases, in a set of cases, that are associated with the one or more attribute values and exhibit the undesirable behavior is determined. The expected frequency of occurrence may be determined from the input case data based on a proportion of cases, in the set of cases, that exhibit the undesirable behavior and an observed frequency of occurrence of cases, in the set of cases, that are associated with the one or more attribute values. In one embodiment, the expected frequency of occurrence of cases that are associated with the one or more attribute values and exhibit the undesirable behavior is determined by multiplying the proportion of cases in the set of cases that exhibit the undesirable behavior (for all attribute values) with the observed frequency of occurrence of cases in the set of cases that are associated with the one or more attribute values (for cases that do and do not exhibit the undesirable behavior). For example, where the input case data is table 300 of FIG. 3, the expected frequency of occurrence of cases, in the set of cases selected by the user, that are associated with the attribute value “services” and exhibit undesirable behavior may be determined as (⅔)×1.

At step 208, the observed frequency of occurrence is compared with the expected frequency of occurrence to determine an influence of the one or more attribute values on the undesirable behavior. The comparison is performed to determine whether the observed frequency of occurrence significantly deviates from the expected frequency of occurrence. When the observed frequency of occurrence is significantly higher than the expected frequency of occurrence, the one or more attribute values are considered to be influential to cases exhibiting the undesirable behavior. When the observed frequency of occurrence is significantly lower than the expected frequency of occurrence, the one or more attribute values are considered to be influential to cases that do not exhibit the undesirable behavior. In one embodiment, the observed frequency of occurrence is compared with the expected frequency of occurrence by computing the standardized residual.

In one embodiment, for example, where the input case data does not include the weight associated with each case, the underlying distribution of data follows a Poisson distribution with a mean and variance equal to the expected frequency of occurrence. As such, the standard residual may be computed in accordance with Equation (1):

$${R}_{i , t a g} = \frac{{O}_{i , tag} - {E}_{i , tag}}{\sqrt{{E}_{i , tag}}} \qquad Equation ( 1 )$$

where R_{i,tag} is the standard residual of the occurrence of cases associated with attribute value i exhibiting undesirable behavior, O_{i,tag} is the observed frequency of occurrence of cases associated with attribute value i exhibiting undesirable behavior, and E_{i,tag} is the expected frequency of occurrence of cases associated with attribute value i exhibiting undesirable behavior.

In one embodiment, for example, where the input case data includes the weight associated with case, the underlying data follows a Compound Poisson distribution (not a Poisson distribution) since the underlying data is not frequency values. As such, the standard residual may be computed in accordance with Equation (2):

$${{R}^{′}}_{i , t a g} = \frac{{W}_{i , tag} - λ \cdot ω}{\sqrt{λ \cdot {ω}^{2}}} \qquad Equation 2 )$$

where W_{i,tag} is the sum of the weights for cases associated with attribute value i exhibiting undesirable behavior, λ is equal to the expected frequency of occurrence E_{i,tag}, and ω is the expected weight. The expected weight ω may be computed by multiplying the mean weight of all cases in the set of cases with the expected frequency of occurrence E_{i,tag}.

In one embodiment, the comparing at step 208 is only performed if 1) the expected frequency of occurrence of cases in the set of cases that are associated with the one or more attribute values and exhibit the undesirable behavior and 2) the expected frequency of occurrence of cases in the set of cases that are associated with the one or more attribute values and do not exhibit the undesirable behavior both satisfy a predetermined expected frequency threshold (e.g., 5 or more). The expected frequency of occurrence of cases in the set of cases that are associated with the attribute value and do not exhibit the undesirable behavior can be computed by multiplying the proportion of cases in the set of cases that do not exhibit the undesirable behavior (for all attribute values) with the frequency of occurrence of cases in the set of cases that are associated with the attribute value (for cases that do and do not exhibit the undesirable behavior). If either of the expected frequencies of occurrence do not satisfy the predetermined expected frequency threshold, the one or more attribute values are not considered for analysis and the analysis ends.

In one embodiment, instead of computing the expected frequencies of occurrence to determine if they satisfy the predetermined expected frequency threshold, an observed frequency threshold T_{tag} may be computed for cases that are associated with the one or more attribute values and exhibit the undesirable behavior and an observed frequency threshold Tᵣₑₛₜ may be computed for cases that are associated with the one or more attribute values and do not exhibit the undesirable behavior that would satisfy the predetermined expected frequency threshold. As discussed above, the expected frequency of occurrence of cases in the set of cases that are associated with the one or more attribute values and do not exhibit the undesirable behavior can be computed by multiplying the proportion of cases in the set of cases that exhibit the undesirable behavior with the observed frequency of occurrence of cases in the set of cases that are associated with the one or more attribute values. Accordingly, by setting the expected frequency of occurrence equal to the predetermined expected frequency threshold, the observed frequency threshold T_{tag} for the observed frequency of occurrence of cases in the set of cases that are associated with the one or more attribute values and exhibit the undesirable behavior can be determined as the predetermined expected frequency threshold divided by the proportion of cases in the set of cases that exhibit the undesirable behavior. Similarly, the observed frequency threshold Tᵣₑₛₜ for the observed frequency of occurrence of cases in the set of cases that are associated with the one or more attribute values and do not exhibit undesirable behavior can be determined as the predetermined expected frequency threshold divided by the proportion of cases in the set of cases that do not exhibit the undesirable behavior. If the observed frequency thresholds T_{tag} and Tᵣₑₛₜ are not satisfied, the one or more attribute values are not considered for analysis and the analysis ends.

At step 210, an impact metric quantifying the influence of the one or more attribute values on the undesirable behavior is computed. In one embodiment, the impact metric has a range between −1 and 1, where a higher value indicates more influence. However, the impact metric may be represented in any suitable manner.

To compute the impact metric, it is first determined whether the impact metric will be positive or negative. A positive impact metric will result when the observed frequency of occurrence is greater than the expected frequency of occurrence for cases that are associated with the one or more attribute values and exhibit undesirable behavior. A negative impact metric will result when the observed frequency of occurrence is not greater than the expected frequency of occurrence for cases that are associated with the one or more attribute values and exhibit undesirable behavior.

The positive impact metric is computed according to Equation (3):

$${Impact}^{+} = \frac{\vert {C}_{t a g} ⋂ {C}_{i} \vert}{\vert {C}_{i} \vert} \cdot \frac{\vert {C}_{t a g} ⋂ {C}_{i} \vert}{\vert {C}_{t a g} \vert} \qquad Equation ( 3 )$$

where C_{tag} is the frequency of occurrence of cases in the set of cases that exhibit the undesirable behavior and Cᵢ is the frequency of occurrence of cases in the set of cases associated with the one or more attribute values.

The negative impact metric is computed according to Equation (4):

$${Impact}^{-} = - \frac{\vert {C}_{rest} ⋂ {C}_{i} \vert}{\vert {C}_{i} \vert} \cdot \frac{\vert {C}_{rest} ⋂ {C}_{i} \vert}{\vert {C}_{rest} \vert} \qquad Equation ( 4 )$$

where Cᵣₑₛₜ is the number of cases in the set of cases that do not exhibit the undesirable behavior.

The impact metric has the maximum value of 1 if and only if 1) all cases associated with the one or more attribute values occur in cases that exhibit the undesirable behavior and do not occur in any the cases that do not exhibit the undesirable behavior (i.e., Cᵢ∩Cᵣₑₛₜ =0), and 2) all cases associated with the one or more attribute values are cases that exhibit the undesirable behavior (i.e., C_{tag}=Cᵢ). The impact metric has the minimum value of −1 when all cases associated with the one or more attribute values do not exhibit undesirable behavior and all cases that exhibit undesirable behavior are cases associated with the one or more attribute values.

In one embodiment, where the input case data includes the weight associated with case, the impact metric is computed as follows:

$$\begin{matrix}{impact}_{w e i g h t}^{+} = \frac{{Σ}_{c ∈ {C}_{t a g} ⋂ {C}_{i}} w e i g h t ( c )}{{Σ}_{c ∈ {C}_{i}} w e i g h t ( c )} \cdot \frac{{Σ}_{c ∈ {C}_{t a g} ⋂ {C}_{i}} w e i g h t ( c )}{{Σ}_{c ∈ {C}_{t a g}} w e i g h t ( c )} & Equation ( 5 ) \\ impa c {t}_{w e i g h t}^{-} = - \frac{{Σ}_{c ∈ {C}_{r e s t} ⋂ {C}_{i}} w e i g h t ( c )}{{Σ}_{c ∈ {C}_{i}} w e i g h t ( c )} \cdot \frac{{Σ}_{c ∈ {C}_{r e s t} ⋂ {C}_{i}} w e i g h t ( c )}{{Σ}_{c ∈ {C}_{r e s t}} w e i g h t ( c )} & Equation ( 6 )\end{matrix}$$

At step 212, the influence of the attribute value on the undesirable behavior and/or the impact metric are output. In one embodiment, the influence of the attribute value on the undesirable behavior and/or the impact metric may be output by, for example, displaying the influence of the attribute value on the undesirable behavior and/or the impact metric on a display device of a computer system, storing the influence of the attribute value on the undesirable behavior and/or the impact metric on a memory or storage of a computer system, or by transmitting the influence of the attribute value on the undesirable behavior and/or the impact metric to a remote computer system.

It should be understood that steps 204-210 of method 200 may be repeated for a number of different attribute values or combinations of attribute values in the input case data, and step 212 may output and compare the influence of the attribute values or combinations of attribute values on the undesirable behavior and/or the impact metrics of the attribute values or combinations of attribute values.

In one embodiment, the influence of the attribute value on the undesirable behavior is output in the format of a table. FIG. 4 shows an exemplary output table 400, in accordance with one or more embodiments. Table 400 may be the output of step 204 of FIG. 2. As shown in FIG. 4, table 400 comprises headings 406 and rows 402 each corresponding to a case of the process and columns 404 identifying various properties of the cases at a cell at which rows 402 and columns 404 intersect. In particular, each row 402 corresponds to a case, which is associated with a case ID (identified in column 404-A) identifying an instance of execution of the process, an attribute (identified in column 404-B), an attribute value of the attribute (identified in column 404-C), an observed frequency of occurrence of cases associated with the attribute value and exhibiting the undesirable behavior (as identified in column 404-D), an observed frequency of occurrence of cases associated with the case and not exhibiting the undesirable behavior (as identified in column 404-E), a sum of the weight of cases associated with the case and exhibiting the undesirable behavior (as identified in column 404-F), and a sum of the weight of cases associated with the case and not exhibiting the undesirable behavior (as identified in column 404-G). It should be understood that table 400 may be in any suitable format and may include additional columns 404 identifying other properties and/or metrics, such as, e.g., the impact metric.

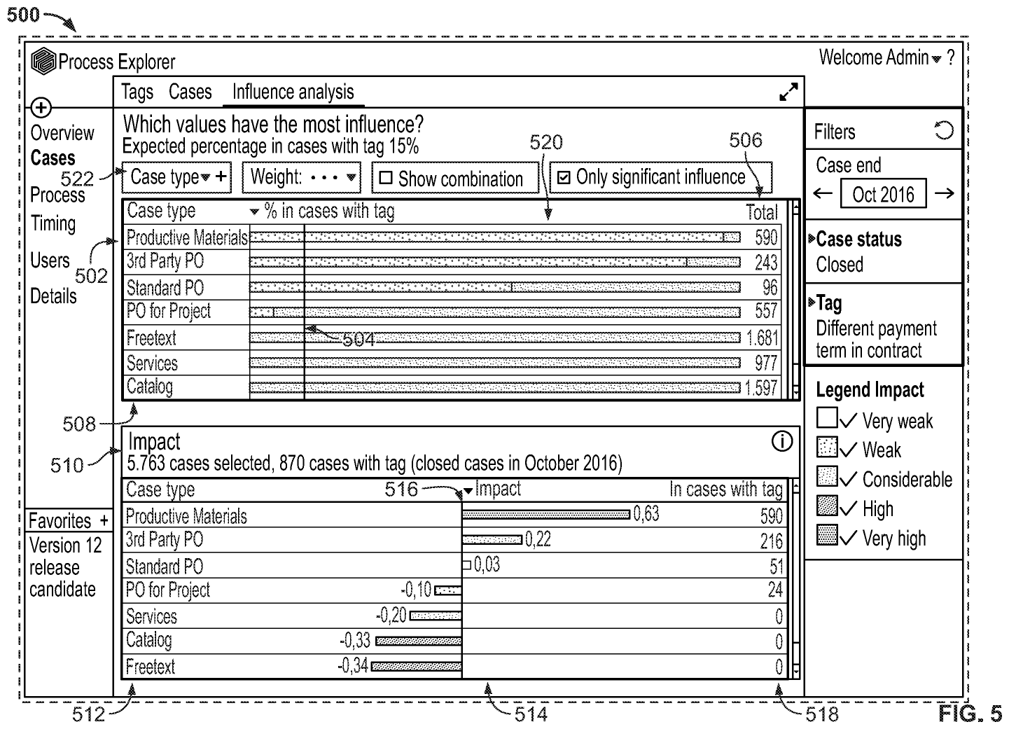

In one embodiment, the influence of the attribute value on the undesirable behavior and/or the impact metric are output on one or more dashboards displayed to a user on a display device. Such dashboards enable filtering and controls to enable a user to select information to be displayed. Exemplary dashboards are shown in FIGS. 5-9, described in detail below.

FIG. 5 shows an exemplary dashboard 500 for visualizing the influence of attribute values on undesirable behavior, in accordance with one or more embodiments. Dashboard 500 comprises a user selection field 522 to enable a user to select one or more attributes for analysis. As shown in dashboard 500, the attribute “case type” is selected.

Portion 502 of dashboard 500 depicts a bar chart 520 showing the deviation of the observed frequency from the expected frequency of cases associated with various attribute values 508 that exhibit undesirable behavior. The expected frequency is represented by line 504 in bar chart 520. When the bars are further from line 504, the deviation is larger. At the end of each bar, at column 506, the total number of cases associated with each attribute value 508 is shown. The attribute values 508 are sorted from largest percentage of cases exhibiting undesirable behavior to lowest, but may be sorted according to any suitable criteria.

Portion 510 of dashboard 500 depicts a bar chart 514 showing impact metric values for various attribute values 512. Line 516 in bar chart 514 represents an impact metric value of zero, where bars to the left of line 516 represent negative impact metric values and bars to the right of line 516 represent positive impact metric values. The attribute values 512 are sorted from highest impact metric value to lowest impact metric value, but may be sorted according to any suitable criteria. At the end of each bar, at column 518, the number of cases associated with the attribute values 512 exhibiting undesirable behavior is shown. The bars in bar chart 514 may be color coded to represent the impact of the attribute values 512. In one embodiment, bar chart 514 is color coded into one of the following categories: very weak, weak, considerable, high, and very high. In one embodiment, a same color code may be used for both positive and negative impact metric values such that, for example, a very weak positive impact metric value and a very weak negative impact metric value are assigned a same color.

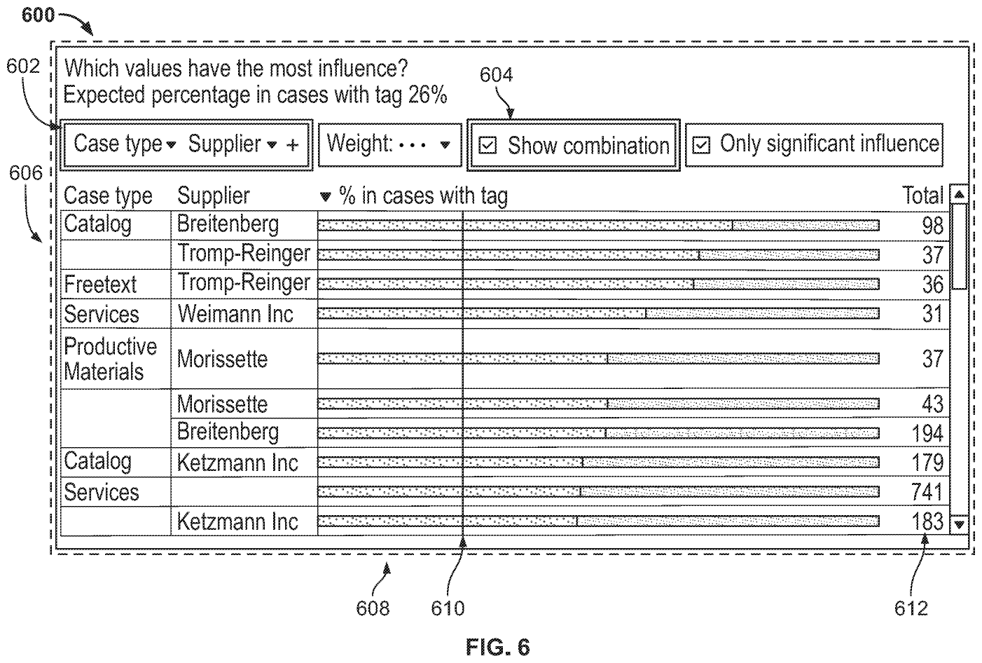

FIG. 6 shows a dashboard 600 for analyzing a deviation of observed frequency from the expected frequency of cases associated with various attribute values that exhibit undesirable behavior, in accordance with one or more embodiments. Dashboard 600 shows user selection field 602 to enable a user to select one or more attributes for analysis and user selection field 604 to enable a user to select the option to show results for a combination of attributes. As shown in dashboard 600, two attributes are selected in user selection field 602: “case type” and “supplier” and the option to show results for a combination of attributes is selected in user selection field 604. Similar to bar chart 520 of FIG. 5, bar chart 608 shows the deviation of the observed frequency from the expected frequency, but also for cases associated with combinations of attribute values 606 that exhibit undesirable behavior. The expected frequency is represented by line 610 in bar chart 608. At the end of each bar, at column 612, the total number of cases associated with each combination of attribute values 606 is shown. By selecting user selection field 604, the combination of attribute values 606 is shown, but this does not remove the single attribute values, such as the second row for example).

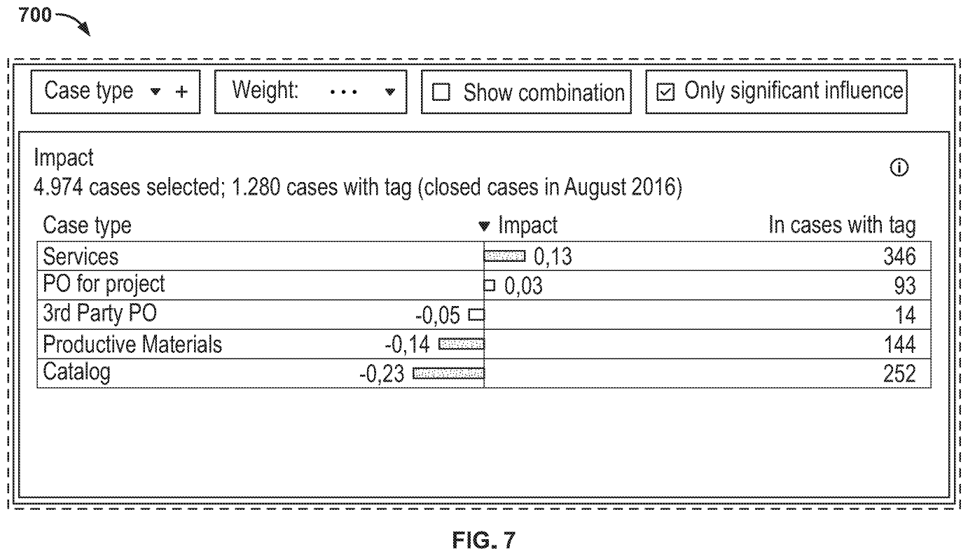

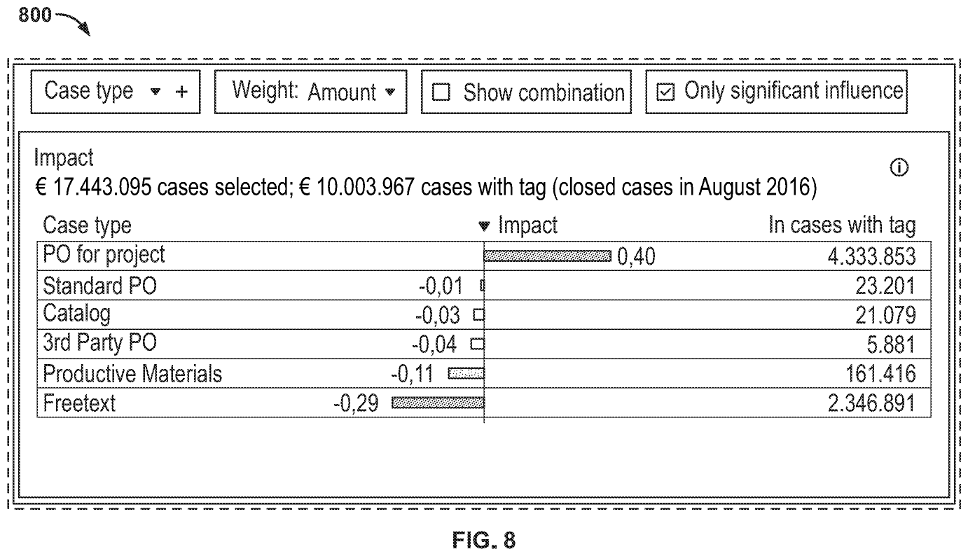

FIG. 7 shows a dashboard 700 showing impact metric values for various attribute values based on frequencies of occurrence and FIG. 8 shows a dashboard 800 showing impact metric values for various attribute values based on weights, in accordance with one or more embodiments.

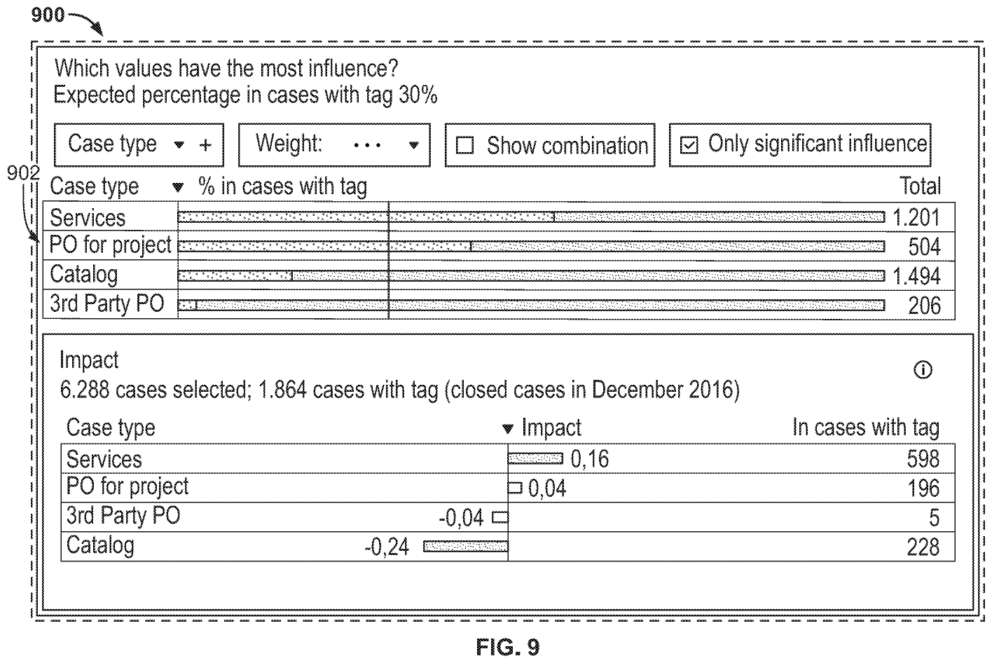

FIG. 9 shows a dashboard 900 visualizing the influence of attribute values on undesirable behavior for an exemplary use case, in accordance with one or more embodiments. In this use case, a user would like to identify influential attribute values with the highest impact on frequently occurring undesirable behavior over a specified period. To perform his analysis, the user selects the set of cases and the undesirable behavior. The set of cases is selected as cases occurring during the month of December 2016 and the undesirable behavior is selected as all invoices paid late (the filtering on which tag is selected is not shown in this figure). During this period, 6288 closed cases occurred, with 30% of the cases exhibiting the undesirable behavior. As shown in FIG. 9, four attribute values 902 of the attribute “case type” are identified as influential, of which two have a positive impact. The attribute value “services” occurs in 1201 cases, of which 598 exhibit the undesirable behavior. The total number of cases exhibiting the undesirable behavior in the set of cases is 1864. This results in a considerable impact metric value of 0.16.

FIG. 10 is a block diagram illustrating a computing system 1000 configured to execute the methods, workflows, and processes described herein, including FIGS. 1-3, according to an embodiment of the present invention. In some embodiments, computing system 1000 may be one or more of the computing systems depicted and/or described herein. Computing system 1000 includes a bus 1002 or other communication mechanism for communicating information, and processor(s) 1004 coupled to bus 1002 for processing information. Processor(s) 1004 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1004 may also have multiple processing cores, and at least some of the cores may be configured to perform specific functions. Multi-parallel processing may be used in some embodiments.

Computing system 1000 further includes a memory 1006 for storing information and instructions to be executed by processor(s) 1004. Memory 1006 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 1004 and may include volatile media, non-volatile media, or both. The media may also be removable, non-removable, or both.

Additionally, computing system 1000 includes a communication device 1008, such as a transceiver, to provide access to a communications network via a wireless and/or wired connection according to any currently existing or future-implemented communications standard and/or protocol.

Processor(s) 1004 are further coupled via bus 1002 to a display 1010 that is suitable for displaying information to a user. Display 1010 may also be configured as a touch display and/or any suitable haptic I/O device.

A keyboard 1012 and a cursor control device 1014, such as a computer mouse, a touchpad, etc., are further coupled to bus 1002 to enable a user to interface with computing system. However, in certain embodiments, a physical keyboard and mouse may not be present, and the user may interact with the device solely through display 1010 and/or a touchpad (not shown). Any type and combination of input devices may be used as a matter of design choice. In certain embodiments, no physical input device and/or display is present. For instance, the user may interact with computing system 1000 remotely via another computing system in communication therewith, or computing system 1000 may operate autonomously.

Memory 1006 stores software modules that provide functionality when executed by processor(s) 1004. The modules include an operating system 1016 for computing system 1000 and one or more additional functional modules 1018 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer implemented method for analyzing influence of one or more attribute values on undesirable behavior exhibited in a set of cases of a process, each case corresponding to an instance of execution of the process, the method comprising:
determining an observed frequency of occurrence of cases that are associated with one or more attribute values and exhibit undesirable behavior;
calculating an expected frequency of occurrence of cases that are associated with the one or more attribute values and exhibit the undesirable behavior, wherein the expected frequency of occurrence is calculated based on a proportion of cases that exhibit the undesirable behavior and a frequency of occurrence of cases that are associated with the one or more attribute values; and
comparing the observed frequency of occurrence with the expected frequency of occurrence to determine the influence of the one or more attribute values on the undesirable behavior.

2. The computer implemented method of claim 1, wherein calculating an expected frequency of occurrence of cases that are associated with the one or more attribute values and exhibit the undesirable behavior comprises:
multiplying the proportion of cases that exhibit the undesirable behavior by the frequency of occurrence of cases that are associated with the one or more attribute values.

3. The computer implemented method of claim 1, wherein comparing the observed frequency of occurrence with the expected frequency of occurrence to determine the influence of the one or more attribute values on the undesirable behavior comprises:
computing a standard residual of the cases that are associated with the one or more attribute values and exhibit the undesirable behavior based on the observed frequency of occurrence and the expected frequency of occurrence.

4. The computer implemented method of claim 1, wherein comparing the observed frequency of occurrence with the expected frequency of occurrence to determine the influence of the one or more attribute values on the undesirable behavior comprises:
computing a standard residual of the cases that are associated with the one or more attribute values and exhibit the undesirable behavior based on 1) a weight associated with each of the cases that are associated with the one or more attribute values and exhibit the undesirable behavior, 2) the expected frequency of occurrence, and 3) an expected weight.

5. The computer implemented method of claim 1, wherein the comparing is performed in response to the expected frequency of occurrence of cases that are associated with the one or more attribute values and exhibit the undesirable behavior and an expected frequency of occurrence of cases that are associated with the one or more attribute values and do not exhibit the undesirable behavior satisfying an expected frequency threshold.

6. The computer implemented method of claim 1, further comprising:
computing an impact metric quantifying the influence of the one or more attribute values on the undesirable behavior.

7. The computer implemented method of claim 6, wherein computing an impact metric quantifying the influence of the one or more attribute values on the undesirable behavior comprises:
determining that the impact metric will be positive; and
computing the positive impact metric based on a frequency of occurrence of cases that exhibit the undesirable behavior and a frequency occurrence of cases associated with the one or more attribute values.

8. The computer implemented method of claim 6, wherein computing an impact metric quantifying the influence of the one or more attribute values on the undesirable behavior comprises:
determining that the impact metric will be negative; and
computing the negative impact metric based on a frequency of occurrence of cases that do not exhibit the undesirable behavior and a frequency occurrence of cases associated with the one or more attribute values.

9. The computer implemented method of claim 1, further comprising:
displaying a dashboard of results of the comparing on a display device.

10. The computer implemented method of claim 1, wherein the process is a robotic process automation process.

11. An apparatus comprising:
a memory storing computer instructions for analyzing influence of one or more attribute values on undesirable behavior exhibited in a set of cases of a process, each case corresponding to an instance of execution of the process; and
at least one processor configured to execute the computer instructions, the computer instructions configured to cause the at least one processor to perform operations of:
determining an observed frequency of occurrence of cases that are associated with one or more attribute values and exhibit undesirable behavior;
calculating an expected frequency of occurrence of cases that are associated with the one or more attribute values and exhibit the undesirable behavior, wherein the expected frequency of occurrence is calculated based on a proportion of cases that exhibit the undesirable behavior and a frequency of occurrence of cases that are associated with the one or more attribute values; and
comparing the observed frequency of occurrence with the expected frequency of occurrence to determine the influence of the one or more attribute values on the undesirable behavior.

12. The apparatus of claim 11, wherein calculating an expected frequency of occurrence of cases that are associated with the one or more attribute values and exhibit the undesirable behavior comprises:
multiplying the proportion of cases that exhibit the undesirable behavior by the frequency of occurrence of cases that are associated with the one or more attribute values.

13. The apparatus of claim 11, wherein comparing the observed frequency of occurrence with the expected frequency of occurrence to determine the influence of the one or more attribute values on the undesirable behavior comprises:
computing a standard residual of the cases that are associated with the one or more attribute values and exhibit the undesirable behavior based on the observed frequency of occurrence and the expected frequency of occurrence.

14. The apparatus of claim 11, wherein comparing the observed frequency of occurrence with the expected frequency of occurrence to determine the influence of the one or more attribute values on the undesirable behavior comprises:
computing a standard residual of the cases that are associated with the one or more attribute values and exhibit the undesirable behavior based on 1) a weight associated with each of the cases that are associated with the one or more attribute values and exhibit the undesirable behavior, 2) the expected frequency of occurrence, and 3) an expected weight.

15. The apparatus of claim 11, wherein the comparing is performed in response to the expected frequency of occurrence of cases that are associated with the one or more attribute values and exhibit the undesirable behavior and an expected frequency of occurrence of cases that are associated with the one or more attribute values and do not exhibit the undesirable behavior satisfying an expected frequency threshold.

16. A computer program embodied on a non-transitory computer-readable medium for analyzing influence of one or more attribute values on undesirable behavior exhibited in a set of cases of a process, each case corresponding to an instance of execution of the process, the computer program configured to cause at least one processor to perform operations comprising:
determining an observed frequency of occurrence of cases that are associated with one or more attribute values and exhibit undesirable behavior;
calculating an expected frequency of occurrence of cases that are associated with the one or more attribute values and exhibit the undesirable behavior, wherein the expected frequency of occurrence is calculated based on a proportion of cases that exhibit the undesirable behavior and a frequency of occurrence of cases that are associated with the one or more attribute values; and
comparing the observed frequency of occurrence with the expected frequency of occurrence to determine the influence of the one or more attribute values on the undesirable behavior.

17. The computer program of claim 16, the operations further comprising:
computing an impact metric quantifying the influence of the one or more attribute values on the undesirable behavior.

18. The computer program of claim 17, wherein computing an impact metric quantifying the influence of the one or more attribute values on the undesirable behavior comprises:
determining that the impact metric will be positive; and
computing the positive impact metric based on a frequency of occurrence of cases that exhibit the undesirable behavior and a frequency occurrence of cases associated with the one or more attribute values.

19. The computer program of claim 17, wherein computing an impact metric quantifying the influence of the one or more attribute values on the undesirable behavior comprises:
determining that the impact metric will be negative; and
computing the negative impact metric based on a frequency of occurrence of cases that do not exhibit the undesirable behavior and a frequency occurrence of cases associated with the one or more attribute values.

20. The computer program of claim 16, the operations further comprising:
displaying a dashboard of results of the comparing on a display device.
